(19) United States
(12) Patent Application Publication
(10) Pub. No.: US 2013/0092849 A1
(43) Pub. Date: Apr. 18, 2013

(54) LASER DEVICE, LASER APPARATUS, AND EXTREME ULTRAVIOLET LIGHT GENERATION SYSTEM

(71) Applicants: Krzysztof Nowak, Oyama-shi (JP); Osamu Wakabayashi, Hiratsuka-shi (JP)

(72) Inventors: Krzysztof Nowak, Oyama-shi (JP); Osamu Wakabayashi, Hiratsuka-shi (JP)

(73) Assignee: GIGAPHOTON INC., Oyama-shi, Tochigi (JP)

(21) Appl. No.: 13/805,249

(22) PCT Filed: Feb. 27, 2012
(86) PCT No.: PCT/IB12/00356

§ 371 Date: Dec. 18, 2012

Related U.S. Application Data
(60) Provisional application No. 61/468,967, filed on Mar. 29, 2011.

(30) Foreign Application Priority Data
Jun. 13, 2011 (JP) 2011-131305
Dec. 26, 2011 (JP) 2011-284289

(51) Int. Cl. H01S 3/10; G21K 5/04

(52) U.S. Cl. CPC H01S 3/10038; G21K 5/04
USPC 250/504 R; 372/38.1

(57) ABSTRACT

A laser device having master oscillators that output seed beams is provided. The seed beams are guided from the master oscillators to a regenerative amplifier such that at least one of the seed beams enters the regenerative amplifier at an angle that differs from an angle at which another seed beam enters the regenerative amplifier. A laser apparatus and an extreme ultraviolet light generation system using the laser device are also provided.

### CROSS-REFERENCE TO RELATED APPLICATIONS

The present application claims the benefit of U.S. Provisional Patent Application Ser. No. 61/468,967 filed Mar. 29, 2011, Japanese Patent Application No. 2011-131305 filed Jun. 13, 2011, and Japanese Patent Application No. 2011-284289 filed Dec. 26, 2011.

### BACKGROUND

1. Technical Field

This disclosure relates to a laser device, a laser apparatus, and an extreme ultraviolet (EUV) light generation system.

2. Related Art

In recent years, semiconductor production processes have become capable of producing semiconductor devices with increasingly fine feature sizes, as photolithography has been making rapid progress toward finer fabrication. In the next generation of semiconductor production processes, microfabrication with feature sizes at 60 nm to 45 nm, and further, microfabrication with feature sizes of 32 nm or less will be required. In order to meet the demand for microfabrication at 32 nm or less, for example, an exposure apparatus is expected to be developed, in which an apparatus for generating extreme ultraviolet (EUV) light at a wavelength of approximately 13 nm is combined with a reduced projection reflective optical system.

Three kinds of systems for generating EUV light are known in general, which include a Laser Produced Plasma (LPP) type system in which plasma is generated by irradiating a target material by a laser beam, a Discharge Produced Plasma (DPP) type system in which plasma is generated by electric discharge, and a Synchrotron Radiation (SR) type system in which orbital radiation is used.

### SUMMARY

A laser device according to one aspect of this disclosure may include: a plurality of master oscillators, each of the master oscillators being configured to output a seed beam; a regenerative amplifier for amplifying the seed beams from the plurality of master oscillators; and an optical system configured to guide the seed beams from the plurality of master oscillators to the regenerative amplifier such that at least one of the seed beams enters the regenerative amplifier at an angle that differs from an angle at which another seed beam enters the regenerative amplifier.

A laser apparatus according to another aspect of this disclosure may include: the aforementioned laser device; and an amplifier for amplifying an amplified laser beam from the laser device.

An extreme ultraviolet light generation system according to yet another aspect of this disclosure may include: the aforementioned laser apparatus; a chamber having an inlet for introducing the laser beam from the laser apparatus into the chamber; a target supply unit for supplying a target material into the chamber; a focusing optical system for focusing the laser beam in the chamber; and a collector mirror for collecting extreme ultraviolet light emitted as the target material is irradiated by the laser beam in the chamber.

### BRIEF DESCRIPTION OF THE DRAWINGS

Hereinafter, selected embodiments of this disclosure will be described with reference to the accompanying drawings.

FIG. 1 schematically illustrates the configuration of an exemplary LPP type EUV light generation system.

FIG. 2 schematically illustrates the configuration of a laser apparatus according to one embodiment of this disclosure.

FIG. 3 schematically illustrates the configuration of a laser apparatus including an optical system according to a first modification of the embodiment.

FIG. 4 schematically illustrates the configuration of a laser apparatus including an optical system according to a second modification of the embodiment.

FIG. 5 schematically illustrates the configuration of a laser apparatus including an optical system according to a third modification of the embodiment.

FIG. 6 schematically illustrates the configuration of a laser apparatus including an optical system according to a fourth modification of the embodiment.

FIG. 7 schematically illustrates the configuration of a regenerative amplifier according to a modification of the embodiment.

FIG. 8 shows the operation of the regenerative amplifier shown in FIG. 7.

FIG. 9 schematically illustrates the configuration of a regenerative amplifier according to another modification of the embodiment.

FIG. 10 is a side view schematically illustrating the configuration of the regenerative amplifier shown in FIG. 9.

FIG. 11 shows gain properties of each gain bandwidth in an amplifier containing CO₂ gas as a gain medium.

FIG. 12 shows the beam intensity of a laser beam LL amplified in accordance with the gain properties shown in FIG. 11.

FIG. 13 shows the gain properties of the gain bandwidths corresponding to modes P(18) through P(30) and the beam intensity of each seed beam.

FIG. 14 shows the beam intensity of the seed beams amplified in accordance with the gain properties shown in FIG. 13.

FIG. 15 shows the relationship, obtained through simulation, among a coupling efficiency, an input-beam diameter of a seed beam, and an input-beam wavefront curvature of the seed beam.

FIG. 16 shows the relationship, obtained through simulation, among a coupling efficiency, an entering angle of a seed beam, and an input-position offset of the seed beam in the horizontal direction.

FIG. 17 shows the relationship, obtained through simulation, among a coupling efficiency, an entering angle of a seed beam, and an input-position offset of the seed beam in the vertical direction.

FIG. 18 shows the relationship, obtained through simulation, among an input-beam diameter of a seed beam, an input-beam wavefront curvature of the seed beam, and an output-beam diameter of an amplified laser beam.

FIG. 19 shows the beam profile, obtained through simulation, of the amplified laser beam.

### DESCRIPTION OF PREFERRED EMBODIMENTS

Hereinafter, selected embodiments of this disclosure will be described in detail with reference to the accompanying drawings. The embodiments to be described below are merely illustrative in nature and do not limit the scope of this disclosure. Further, configurations and operations described in each embodiment are not all essential in implementing this disclosure. Like elements are referenced by like reference numerals and symbols, and duplicate descriptions thereof will be omitted herein. The embodiments of this disclosure will be described following the table of contents below.

### CONTENTS

### 1. Overview

### 2. Terms

### 3. Overview of EUV Light Generation System

### 3.1 Configuration

### 3.2 Operation

4. Laser Apparatus Including multiple Master Oscillators

### 4.1 Configuration

### 4.2 Operation

### 4.3 Effect

### 5. Optical System for Directing Seed Beams to Regenerative Amplifier at Such Angle and Position That Enable Seed Beams to Be Amplified in Regenerative Amplifier

### 5.1 Optical System Including Multiple Reflective Optical Elements (First Modification)

### 5.2 Optical System Including Refractive Optical Element (Second Modification)

6. Optical System for Directing Seed Beams to Regenerative Amplifier While Converting Seed Beams into Diverging Beam

### 6.1 Optical System Including Optical Fiber (Third Modification)

### 6.1.1 Configuration

### 6.1.2 Operation

### 6.1.3 Effect

### 6.2 Optical System Including Beam Diffusion Element (Fourth Modification)

### 6.2.1 Configuration

### 6.2.2 Operation

### 6.2.3 Effect

### 7. Supplementary Descriptions

### 7.1 Modifications of Regenerative Amplifier

### 7.1.1 Configuration

### 7.1.2 Operation

### 7.1.3 Another Modification

### 7.2 Gain Properties in Amplifier Containing CO₂ Gas and Multi-line Amplification

### 7.2.1 Gain Bandwidths in Amplifier Containing CO₂ Gas

### 7.2.2 Multi-line Amplification Using Multiple Master Oscillators

### 7.3 Simulation on Permissible Ranges

### 7.3.1 Simulation Conditions

### 7.3.2 Simulation Results

### 1. OVERVIEW

According to the embodiment and the modifications thereof described hereinafter, a seed beam may be directed into a regenerative amplifier at such an angle and a position that enables the seed beam to be amplified in the regenerative amplifier.

### 2. TERMS

Terms used in this application may be interpreted as follows. In a beam path of a laser beam, a direction or side closer to the laser apparatus is referred to as “upstream,” and a direction or side closer to the plasma generation region is referred to as “downstream.”

In an optical element, the “plane of incidence” refers to a plane perpendicular to a surface on which the laser beam is incident and containing the beam axis of the laser beam incident thereon. A polarization component perpendicular to the plane of incidence is referred to as the “S-polarization component,” and a polarization component parallel to the plane of incidence is referred to as the “P-polarization component.”

The term “permissible entering angle range” may include an angular range of an entering laser beam with respect to a designed input axis of a regenerative amplifier. A laser beam that enters the regenerative amplifier at an angle within the permissible entering angle range can be amplified in and outputted from the regenerative amplifier. The permissible entering angle range may be defined in terms of a solid angle with a given position serving as the vertex of the angle. The term “permissible input-position offset range” may include a two-dimensional range on a plane perpendicular to the designed input axis of the regenerative amplifier. A laser beam that enters the regenerative amplifier at a position within the permissible input-position offset range can be amplified in and outputted from the regenerative amplifier. A laser beam can be amplified even though the axis of the laser beam is parallel to, but offset from, the designed axis as long as such offset is within the “permissible input-position offset range.” The permissible input-position offset range may be defined in a two-dimensional coordinate system with the given position serving as the center (origin). The designed input axis of the regenerative amplifier may be a theoretical axis set when the regenerative amplifier is designed, manufactured, refurbished, and so forth. Alternatively, the designed input axis may be set, after a regenerative amplifier is manufactured, through an amplification simulation for optimizing the operation of the regenerative amplifier. The aforementioned given position may be a position at which the designed input axis intersects with a plane of a polarizer on which the laser beam is first incident upon entering the regenerative amplifier.

### 3. OVERVIEW OF EUV LIGHT GENERATION SYSTEM

### 3.1 Configuration

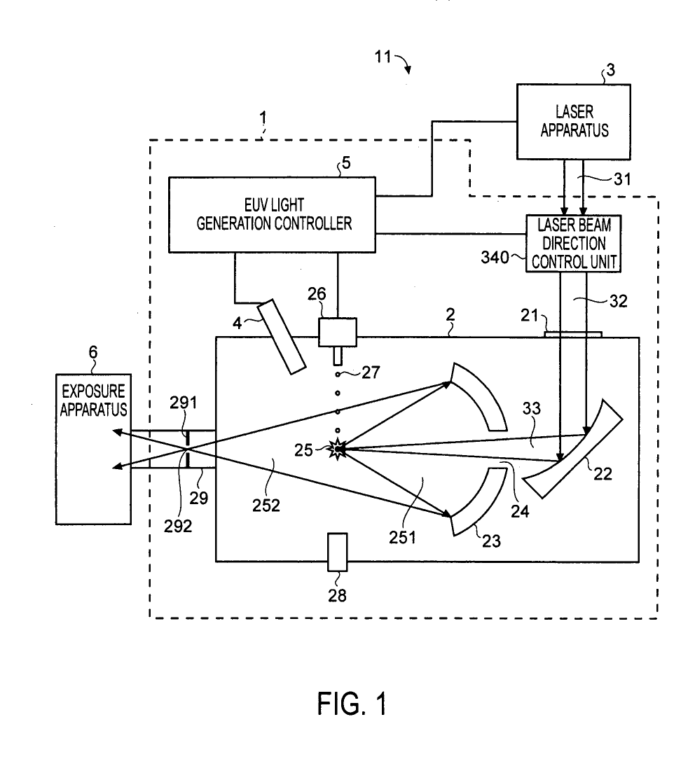

FIG. 1 schematically illustrates the configuration of an exemplary LPP type EUV light generation system. An EUV light generation apparatus 1 may be used with at least one laser apparatus 3. In this application, a system including the EUV light generation apparatus 1 and the laser apparatus 3 may be referred to as an EUV light generation system 11. As illustrated in FIG. 1 and described in detail below, the EUV light generation apparatus 1 may include a chamber 2 and a target supply unit (droplet generator 26, for example). The chamber 2 may be airtightly sealed. The target supply unit 26 may be mounted to the chamber 2 so as to pass through a wall of the chamber 2, for example. A target material to be supplied by the target supply unit 26 may include, but is not limited to, tin, terbium, gadolinium, lithium, xenon, or any combination thereof.

The chamber 2 may have at least one through-hole formed in the wall thereof. The through-hole may be covered with a window 21, and a pulsed laser beam 32 may travel through the window 21 into the chamber 2. An EUV collector mirror 23 having a spheroidal surface may be provided inside the chamber 2, for example. The EUV collector mirror 23 may have a multi-layered reflective film formed on the spheroidal surface thereof, and the reflective film may include molybdenum and silicon that is laminated in alternate layers, for example. The EUV collector mirror 23 may have a first focus and a second focus. The EUV collector mirror 23 may preferably be positioned such that the first focus thereof lies in a plasma generation region 25 and the second focus thereof lies in an intermediate focus (IF) region 292 defined by the specification of an exposure apparatus. The EUV collector mirror 23 may have a through-hole 24 formed at the center thereof, and a pulsed laser beam 33 may travel through the through-hole 24.

Referring again to FIG. 1, the EUV light generation system 11 may include an EUV light generation controller 5. Further, the EUV light generation apparatus 1 may include a target sensor 4. The target sensor 4 may be equipped with an imaging function and may detect at least one of the presence, trajectory, and position of a target.

The EUV light generation apparatus 1 may include a connection part 29 for allowing the interior of the chamber 2 and the interior of the exposure apparatus 6 to be in communication with each other. A wall 291 having an aperture may be provided inside the connection part 29. The wall 291 may be positioned such that the second focus of the EUV collector mirror 23 lies in the aperture formed in the wall 291.

Further, the EUV light generation system 11 may include a laser beam direction control unit 340, a laser beam focusing mirror 22, and a target collection unit 28 for collecting the targets 27. The laser beam direction control unit 340 may include an optical element for defining the direction in which the laser beam travels and an actuator for adjusting the position and the orientation (or posture) of the optical element.

### 3.2 Operation

With reference to FIG. 1, a pulsed laser beam 31 outputted from the laser apparatus 3 may pass through the laser beam direction control unit 340, and may be outputted from the laser beam direction control unit 340 as a pulsed laser beam 32 after having its direction optionally adjusted. The pulsed laser beam 32 may travel through the window 21 and enter the chamber 2. The pulsed laser beam 32 may travel inside the chamber 2 along at least one beam path from the laser apparatus 3, be reflected by the laser beam focusing mirror 22, and strike at least one target 27, as a pulsed laser beam 33.

The droplet generator 26 may output the targets 27 toward the plasma generation region 25 inside the chamber 2. The target 27 may be irradiated by at least one pulse of the pulsed laser beam 33. The target 27, which has been irradiated by the pulsed laser beam 33, may be turned into plasma, and rays of light including EUV light 251 may be emitted from the plasma. The EUV light 251 may be reflected selectively by the EUV collector mirror 23. EUV light 252 reflected by the EUV collector mirror 23 may travel through the intermediate focus region 292 and be outputted to the exposure apparatus 6. The target 27 may be irradiated by multiple pulses included in the pulsed laser beam 33.

The EUV light generation controller 5 may integrally control the EUV light generation system 11. The EUV light generation controller 5 may process image data of the droplet 27 captured by the target sensor 4. Further, the EUV light generation controller 5 may control at least one of the timing at which the target 27 is outputted and the direction into which the target 27 is outputted (e.g., the timing at which and/or direction in which the target is outputted from droplet generator 26), for example. Furthermore, the EUV light generation controller 5 may control at least one of the timing at which the laser apparatus 3 oscillates (e.g., by controlling laser apparatus 3), the direction in which the pulsed laser beam 31 travels (e.g., by controlling laser beam direction control unit 340), and the position at which the pulsed laser beam 33 is focused (e.g., by controlling laser apparatus 3, laser beam direction control unit 340, or the like), for example. The various controls mentioned above are merely examples, and other controls may be added or substituted as desired.

### 4. LASER APPARATUS INCLUDING MULTIPLE MASTER OSCILLATORS

One embodiment of this disclosure will be described in detail with reference to the drawings. In the description to follow, the configuration similar to that of the above-described LPP type EUV light generation system will be referenced by similar reference characters, and duplicate descriptions thereof will be omitted.

### 4.1 Configuration

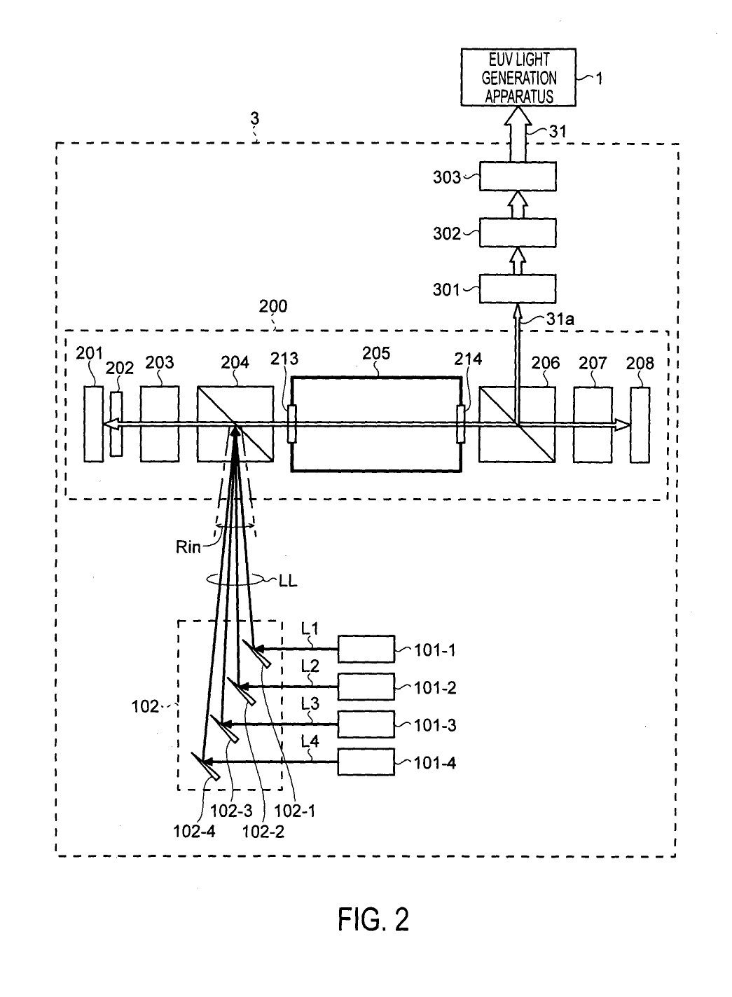

FIG. 2 schematically illustrates the configuration of a laser apparatus 3 according to this embodiment. As illustrated in FIG. 2, the laser apparatus 3 may include master oscillators 101-1 through 101-4, an optical system 102, a regenerative amplifier 200, and amplifiers 301 through 303.

Each of the master oscillators 101-1 through 101-4 may be a single-longitudinal-mode quantum cascade laser, a single-longitudinal-mode CO₂ gas laser, or the like. Each of the master oscillators 101-1 through 101-4 may preferably oscillate at a wavelength which can be amplified in the amplifiers 301 through 303 containing CO₂ gas as a gain medium.

The optical system 102 may include high-reflection mirrors 102-1 through 102-4 positioned so as to reflect seed beams L1 through L4, respectively, outputted from the respective master oscillators 101-1 through 101-4. Each of the high-reflection mirrors 102-1 through 102-4 may include a wedge substrate coated with a high-reflection film. A ridge line of the wedge substrate may be in a knife-edge shape. Alternatively, a flat substrate may be used in place of a wedge substrate. The high-reflection mirrors 102-1 through 102-4 may be positioned with respect to the respective master oscillators 101-1 through 101-4 and to the regenerative amplifier 200 such that the seed beams L1 through L4 reflected by the respective high-reflection mirrors 102-1 through 102-4 enter the regenerative amplifier 200 at angles within a permissible entering angle range Rin and at positions within a permissible input-position offset range.

The regenerative amplifier 200 may include reverser mirrors 201 and 208, a quarter-wave plate 202, EO Pockels cells 203 and 207, polarizers 204 and 206, and a slab amplification unit 205. The slab amplification unit 205 may be filled with a gain medium, such as CO₂ gas.

The quarter-wave plate 202, the EO Pockels cell 203, the polarizer 204, the slab amplification unit 205, the polarizer 206, and the EO Pockels cell 207 may be arranged in this order in an optical resonator formed by the reverser mirrors 201 and 208. In FIG. 2, the polarizers 204 and 206 may be arranged such that the respective reflective surfaces thereof lie on a plane orthogonal to the paper surface. However, the arrangement is not limited thereto. Similar effects to those described below can be obtained as long as the polarizers 204 and 206 are arranged such that the orientation of the polarizers 204 and 206 and the polarization direction of a laser beam incident on the respective polarizers 204 and 206 satisfy the relationship described below.

The quarter-wave plate 202 may generate a 90-degree phase shift in a laser beam passing therethrough. The polarizers 204 and 206 may each be a polarization beam splitter configured to reflect, of a laser beam incident thereon, the S-polarization component with high reflectivity and transmit the P-polarization component with high transmissivity. The slab amplification unit 205 may include windows 213 and 214, through which a laser beam may travel into or out of the slab amplification unit 205. The polarizer 204, the EO Pockels cell 203, and the quarter-wave plate 202 may jointly serve as an input coupling part for introducing a laser beam into the regenerative amplifier 200. The polarizer 206 and the EO Pockels cell 207 may jointly serve as an output coupling part for outputting an amplified laser beam from the regenerative amplifier 200.

Each of the amplifiers 301 through 303 may contain CO₂ gas as a gain medium. The amplifiers 301 through 303 may be arranged in this order downstream from the regenerative amplifier 200.

### 4.2 Operation

The master oscillators 101-1 through 101-4 may respectively output the seed beams L1 through L4, and each of the seed beam L1 through L4 may be linearly polarized. The seed beams L1 through L4 may be reflected by the high-reflection mirrors 102-1 through 102-4, respectively. The reflected seed beams L1 through L4 may then be incident on the polarizer 204, as a seed beam LL. Here, the seed beam LL may preferably be incident on the polarizer 204 mostly as the S-polarization component.

The operation of the regenerative amplifier 200 will now be described. The S-polarization component of the seed beam LL may be reflected by the polarizer 204. With this, the seed beam LL may be introduced into the optical resonator formed by the reverser mirrors 201 and 208. The seed beam LL, which has been introduced in the optical resonator, may first travel through the EO Pockels cell 203, to which a voltage is not applied, with the seed beam LL retaining its polarization state. Then, the seed beam LL may be transmitted through the quarter-wave plate 202, to thereby be converted into a circularly polarized seed beam. The seed beam LL may then be reflected by the reverser mirror 201, and again be transmitted through the quarter-wave plate 202, to thereby be converted into a linearly polarized seed beam. The seed beam LL may then travel through the EO Pockels cell 203, to which a voltage is not applied, and be incident on the polarizer 204 as mostly the P-polarization component. The seed beam LL may thus be transmitted through the polarizer 204 and may enter the slab amplification unit 205 through the window 213.

As stated above, the slab amplification unit 205 may be filled with CO₂ gas serving as a gain medium. The seed beam LL which has entered the slab amplification unit 205 may be amplified as it travels inside the slab amplification unit 205 while retaining its polarization state. The amplified seed beam LL may be outputted from the slab amplification unit 205 through the window 214. The seed beam LL may then be incident on the polarizer 206 mostly as the P-polarization component, and thus be transmitted therethrough. The seed beam LL transmitted through the polarizer 206 may then travel through the EO Pockels cell 207, to which a voltage is not applied, while retaining its polarization state. Thereafter, the seed beam LL may be reflected by the reverser mirror 208, may again travel through the EO Pockels cell 207, to which a voltage is not applied. Then the seed beam LL may be incident on the polarizer 206 mostly as the P-polarization component, and thus be transmitted therethrough. Subsequently, the seed beam LL may again enter the slab amplification unit 205 through the window 214, be further amplified as it travels through the gain medium inside the slab amplification unit 205, and be outputted through the window 213. The seed beam LL may then be incident on the polarizer 204 mostly as the P-polarization component, and thus be transmitted therethrough.

At this point, a voltage may be applied to the EO Pockels cell 203. The seed beam LL may travel through the EO Pockels cell 203, to which the voltage is applied, to thereby be converted into a circularly polarized seed beam. The seed beam LL may then be transmitted through the quarter-wave plate 202, to thereby be converted into a linearly polarized seed beam. The seed beam LL may then be reflected by the reverser mirror 201 and may again be transmitted through the quarter-wave plate 202, to thereby be converted into a circularly polarized seed beam. The seed beam LL may then travel through the EO Pockels cell 203, to which the voltage is applied, to thereby be converted into a linearly polarized seed beam. Here, the seed beam LL may be incident on the polarizer 204 mostly as the P-polarization component, and thus be transmitted therethrough. Then, the seed beam LL may again enter the slab amplification unit 205 through the window 213.

In this way, the seed beam LL which has entered the regenerative amplifier 200 may be amplified as it travels back and forth in the optical resonator formed by the reverser mirrors 201 and 208.

After the seed beam LL has traveled back and forth for a predetermined number of times in the optical resonator, a voltage may be applied to the EO Pockels cell 207. The voltage may be applied to the EO Pockels cell 207 before the seed beam LL from the polarizer 206 enters the EO Pockets cell 207. With this, the seed beam LL, which is linearly polarized, may be converted into a circularly polarized seed beam as it travels through the EO Pockels cell 207, to which the voltage is applied. The seed beam LL may then be reflected by the reverser mirror 208. The circularly polarized seed beam LL may again travel through the EO Pockels cell 207, to which the voltage is applied, to thereby be converted into a linearly polarized seed beam. Here, the seed beam LL may be incident on the polarizer 206 mostly as the S-polarization component, whereby the seed beam LL may be reflected by the polarizer 206 and be outputted from the regenerative amplifier 200 as a laser beam 31a. After the laser beam 31a is outputted from the regenerative amplifier 200, application of the voltages to the EO Pockels cells 203 and 207 may be paused, and the regenerative amplifier 200 may stand by until a subsequent seed beam LL enters the regenerative amplifier 200.

Here, as the seed beam LL that has entered the regenerative amplifier 200 travels back and forth for a predetermined number of times in the optical resonator, a portion of the seed beam LL which is close to the center axis of the regenerative amplifier 200 can be amplified. Accordingly, the seed beam LL reflected by the optical system 102 may preferably enter the regenerative amplifier 200 at an angle within the permissible entering angle range Rin and at a position within the permissible input-position offset range.

The amplified laser beam 31a may be further amplified in the amplifiers 301 through 303, and may be outputted from the amplifier 303 as a laser beam 31. The amplified laser beam 31 may be introduced into the EUV light generation apparatus 1.

### 4.3 Effect

According to this embodiment, the optical system 102 may be arranged with respect to the master oscillators 101-1 through 101-4 and to the regenerative amplifier 200 such that the seed beam LL reflected by the optical system 102 may enter the regenerative amplifier 200 at an angle within the permissible entering angle range Rin and at a position within the permissible input-position offset range. With this, the seed beams L1 through L4 outputted from the respective master oscillator 101-1 through 101-4 may be amplified in a single regenerative amplifier 200. Further, according to this embodiment, a device (for example, a partial-reflection mirror or a grating) for making the beam paths of the seed beams L1 through L4 coincide with one another is not required. Thus, an injection efficiency of the seed beam LL into the regenerative amplifier 200 may be improved.

In the above-described embodiment, the optical system 102 includes the high-reflection mirrors 102-1 through 102-4. However, this disclosure is not limited thereto. For example, the optical system may include a high-reflection mirror, a refracting prism, a high-reflection prism, or the like. That is, any optical system that is capable of intruding a seed beam into a regenerative amplifier at an angle within the permissible entering angle range Rin and at a position within the permissible input-position offset range may be used as the optical system in this disclosure.

### 5. OPTICAL SYSTEM FOR DIRECTING SEED BEAMS TO REGENERATIVE AMPLIFIER AT SUCH ANGLE AND POSITION THAT ENABLE SEED BEAMS TO BE AMPLIFIED IN REGENERATIVE AMPLIFIER

Other examples of the above-described optical system 102 will now be described in detail with reference to the drawings as modifications.

### 5.1 Optical System Including Multiple Reflective Optical Elements (First Modification)

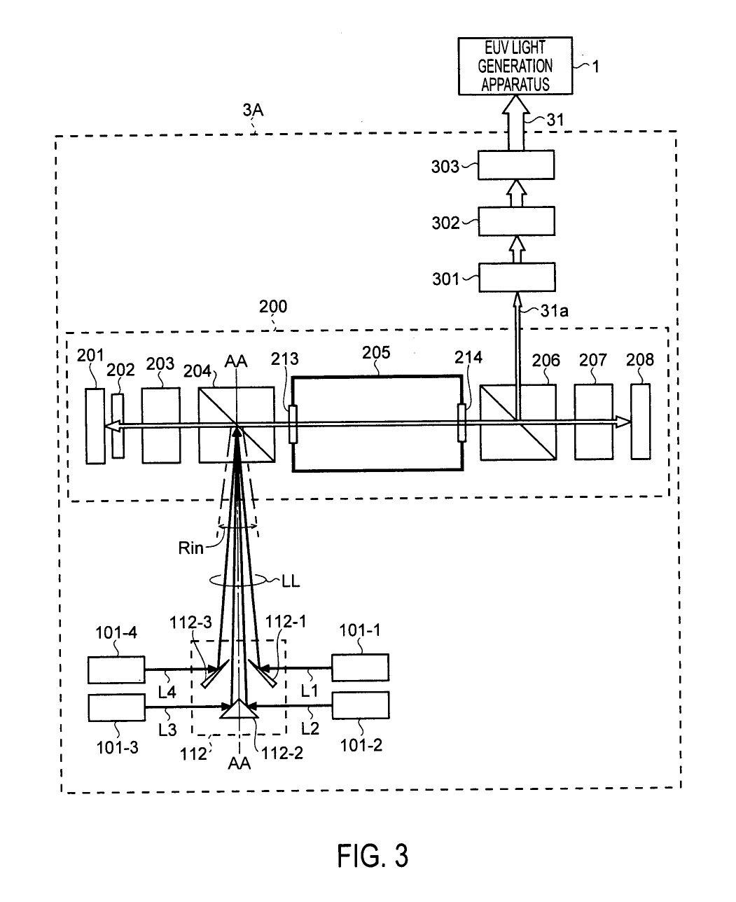

FIG. 3 schematically illustrates the configuration of a laser apparatus 3A including an optical system 112 according to a first modification. The laser apparatus 3A shown in FIG. 3 may be similar in configuration to the laser apparatus 3 shown in FIG. 2. However, the laser apparatus 3A may differ from the laser apparatus 3 in that the optical system 102 is replaced by the optical system 112. Further, the arrangement of the master oscillators 101-1 through 101-4 may be changed in the laser apparatus 3A along with the replacement of the optical system 102 by the optical system 112.

The optical system 112 may include high-reflection mirrors 112-1 and 112-3, and a high-reflection prism 112-2. Each of the high-reflection mirrors 112-1 and 112-3 may include a wedge substrate coated with a high-reflection film. A ridge line of the wedge substrate may be in a knife-edge shape. The high-reflection prism 112-2 may include a wedge substrate coated with a high-reflection film. Preferably, the high-reflection prism 112-2 may be a knife-edge prism, and two surfaces forming the vertical angle of the knife-edge prism may be coated with high-reflection films.

The high-reflection mirrors 112-1 and 112-3 may be positioned such that the seed beams L1 and L4 outputted from the respective master oscillators 101-1 and 101-4 are reflected toward the regenerative amplifier 200. The high-reflection prism 112-2 may be positioned such that the seed beams L2 and L3 outputted from the respective master oscillators 101-2 and 101-3 are reflected toward the regenerative amplifier 200.

More specifically, the high-reflection mirrors 112-1 and 112-3 and the high-reflection prism 112-2 may be positioned with respect to the master oscillators 101-1 through 101-4 and to the regenerative amplifier 200, such that the seed beams L1 through L4 reflected by the high-reflection mirrors 112-1 and 112-3 and the high-reflection prism 112-2, enter the regenerative amplifier 200 at an angle within the permissible entering angle range Rin and at a position within the permissible input-position offset range. The master oscillators 101-1 through 101-4 and the optical system 112 may preferably be positioned such that optical elements included in the master oscillators 101-1 through 101-4 and in the optical system 112 are arranged substantially point-symmetrically with respect to an input axis AA of the seed beams L1 through L4 into the regenerative amplifier 200.

According to the first modification, the number of optical elements for constituting the optical system may be reduced.

### 5.2 Optical System Including Refractive Optical Element (Second Modification)

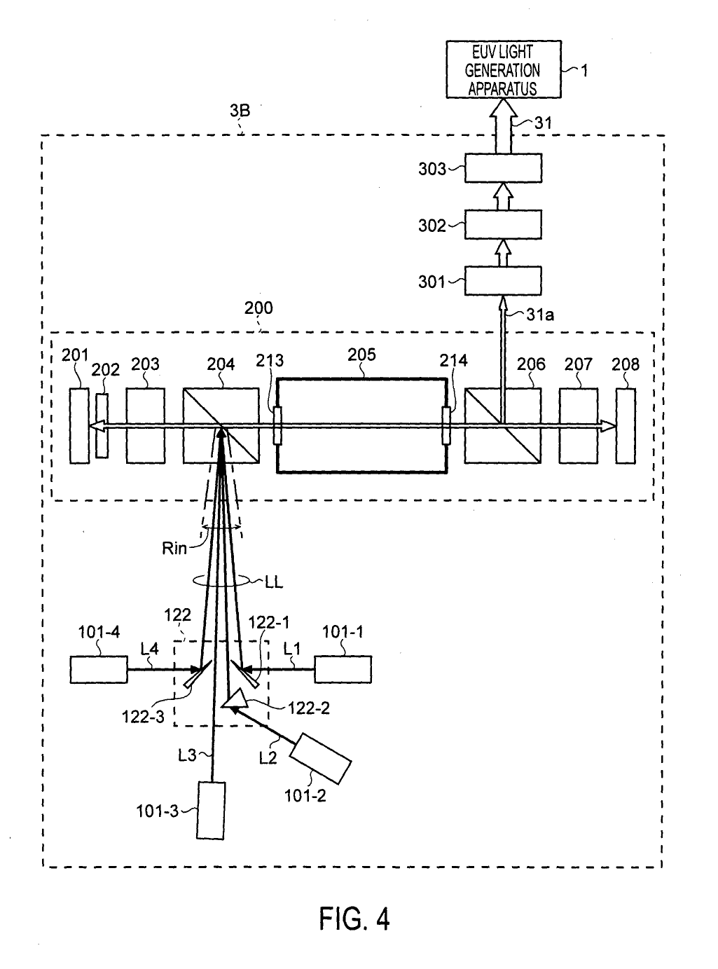

FIG. 4 schematically illustrates the configuration of a laser apparatus 3B including an optical system 122 according to a second modification. The laser apparatus 3B shown in FIG. 4 may be similar in configuration to the laser apparatus 3 shown in FIG. 2. However, the laser apparatus 3B may differ from the laser apparatus 3 in that the optical system 102 is replaced by the optical system 122. Further, the arrangement of the master oscillators 101-1 through 101-4 may be changed in the laser apparatus 3B along with the replacement of the optical system 102 by the optical system 122.

The optical system 122 may include high-reflection mirrors 122-1 and 122-3, and a refractive prism 122-2. Each of the high-reflection mirrors 122-1 and 122-3 may include a wedge substrate coated with a high-reflection film. A ridge line of the wedge substrate may be in a knife-edge shape. The refractive prism 122-2 may include a wedge substrate coated with an antireflection film. Preferably, the refractive prism 122-2 may be a knife-edge prism, and two surfaces forming the vertical angle of the refractive prism 122-2 may be coated with antireflection films.

The high-reflection mirrors 122-1 and 122-3 may be positioned such that the seed beams L1 and L4 outputted from the master oscillators 101-1 and 101-4, respectively, are reflected toward the regenerative amplifier 200. The refractive prism 122-2 may be positioned such that the seed beam L2 outputted from the master oscillator 101-2 is refracted toward the regenerative amplifier 200. Here, the seed beam L3 outputted from the master oscillator 101-3 may directly enter the regenerative amplifier 200.

More specifically, the high-reflection mirrors 122-1 and 122-3 may be positioned with respective to the master oscillators 101-1 and 101-4 and to the regenerative amplifier 200 such that the seed beams L1 and L4 reflected by the high-reflection mirrors 122-1 and 122-3, respectively, enter the regenerative amplifier 200 at an angle within the permissible entering angle range Rin and at a position within the permissible input-position offset range. The refractive prism 122-2 may be positioned with respect to the master oscillator 101-2 and to the regenerative amplifier 200 such that the seed beam L2 refracted through the refractive prism 122-2 enters the regenerative amplifier 200 at an angle within the permissible entering angle range Rin and at a position within the permissible input-position offset range. The master oscillator 101-3 may be positioned with respect to the regenerative amplifier such that the seed beam L3 outputted from the master oscillator 101-3 enters the regenerative amplifier 200 at an angle within the permissible entering angle range Rin and at a position within the permissible input-position offset range.

According to the second modification, the number of optical elements for constituting the optical system may be reduced, as in the first modification.

### 6. OPTICAL SYSTEM FOR DIRECTING SEED BEAMS TO REGENERATIVE AMPLIFIER WHILE CONVERTING SEED BEAMS INTO DIVERGING BEAM

### 6.1 Optical System Including Optical Fiber (Third Modification)

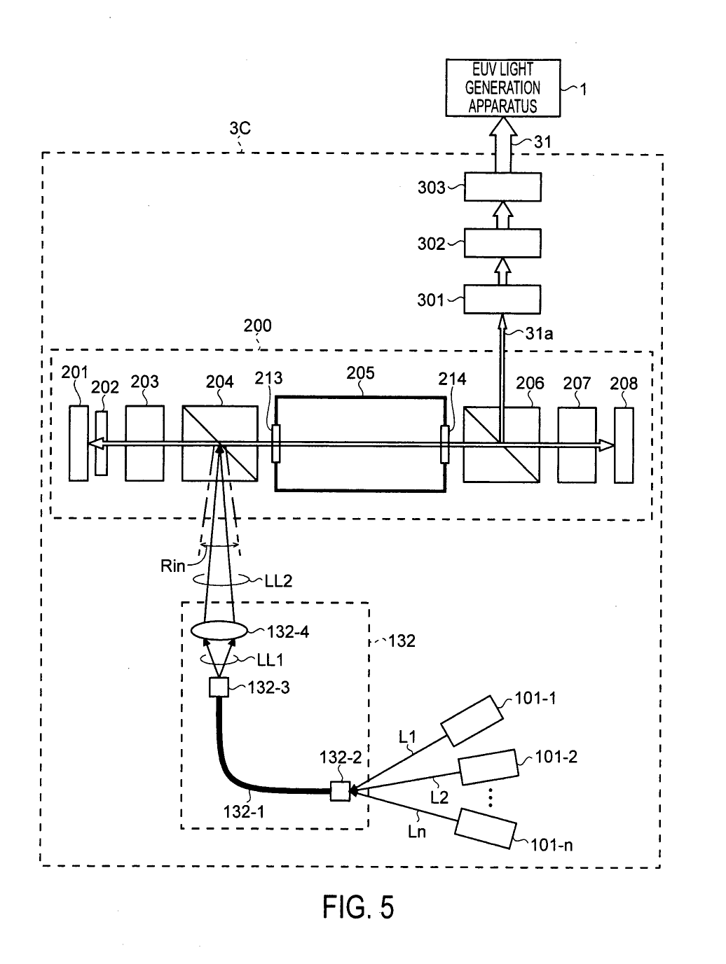

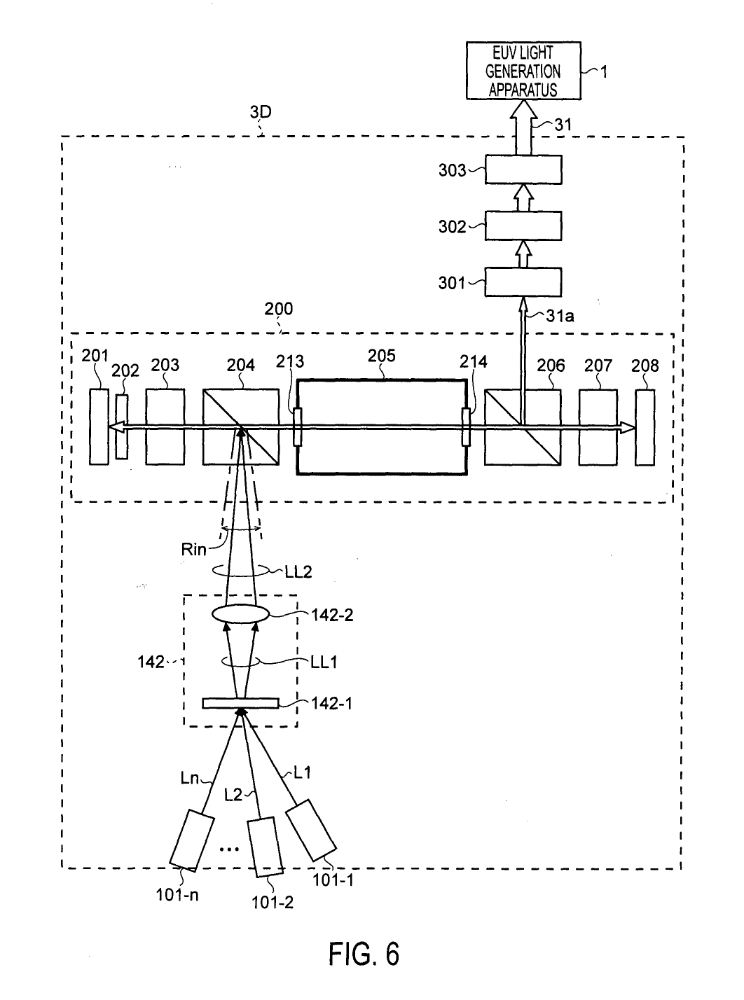

As shown in FIGS. 5 and 6, a bundle of the seed beams L1 through Ln outputted from the respective master oscillators 101-1 through 101-n may be a diverging seed beam LL1. The diverging seed beam LL1 may be converted into a converging seed beam LL2. The converging seed beam LL2 may include a component that can be amplified in the regenerative amplifier 200.

### 6.1.1 Configuration

FIG. 5 schematically illustrates the configuration of a laser apparatus 3C including an optical system 132 according to a third modification. The laser apparatus 3C shown in FIG. 5 may be similar in configuration to the laser apparatus 3 shown in FIG. 2. However, the laser apparatus 3C may differ from the laser apparatus 3 in that the optical system 102 is replaced by the optical system 132. Further, the arrangement of the master oscillators 101-1 through 101-n may be changed in the laser apparatus 3C along with the replacement of the optical system 102 by the optical system 132. Further, in the laser apparatus 3C, the converging seed beam LL2, instead of the seed beam LL, may enter the regenerative amplifier 200.

The optical system 132 may include a waveguide part (optical fiber 132-1, for example) and a focusing lens 132-4. The optical fiber 132-1 may serve to guide the seed beams L1 through Ln and output the diverging seed beam LL1.

The master oscillators 101-1 through 101-n may be positioned such that the seed beams L1 through Ln outputted from the respective master oscillators 101-1 through 101-n enter an optical input part 132-2 of the optical fiber 132-1. The optical input part 132-2 may be a pigtail of the optical fiber 132-1. The master oscillators 101-1 through 101-n may preferably be positioned such that the seed beams L1 through Ln outputted from the respective master oscillators 101-1 through 101-n enter the optical input part 132-2 at an angle within a range of the numerical aperture (NA) of the optical fiber 132-1. With this, the seed beams L1 through Ln that have enter the optical input part 132-2 at an angle within the range of the NA of the optical fiber 132-1 can be propagated through the optical fiber 132-1.

The seed beams L1 through Ln that have entered the optical fiber 132-1 may be outputted through an optical output part 132-3 as the diverging seed beam LL1. The optical output part 132-3 may be another pigtail of the optical fiber 132-1.

The focusing lens 132-4 may be positioned such that the diverging seed beam LL1 outputted from the optical output part 132-3 is incident thereon and enters the regenerative amplifier 200 after being converted into the converging seed beam LL2. Here, the optical output part 132-3 and the focusing lens 132-4 may be positioned with respect to the regenerative amplifier 200 such that the converging seed beam LL2 enters the regenerative amplifier 200 at an angle within the permissible entering angle range Rin and at a position within the permissible input-position offset range. The focusing lens 132-4 may be omitted. When the focusing lens 132-4 is omitted, only a segment of the diverging seed beam LL1 which can enter the regenerative amplifier 200 at an angle within the permissible entering angle range Rin and at a position within the permissible input-position offset range may be amplified in the regenerative amplifier 200.

Here, the optical fiber 132-1 may preferably be configured so as to be capable of propagating a seed beam at wavelengths that can be amplified in the regenerative amplifier 200 containing CO₂ gas as a gain medium. The optical fiber 132-1 may include PolyEtherEtherKetone (PEEK) resin or any other suitable material. The core of the optical fiber 132-1 may be silver halide or any other suitable material, for example. In place of the optical fiber 132-1, a hollow light pipe coated with a high-reflection film on the inner surface thereof may be used. Here, the optical fiber 132-1 may preferably be a polarization-maintaining optical fiber.

### 6.1.2 Operation

The seed beams L1 through Ln outputted from the respective master oscillators 101-1 through 101-n may enter the optical input part 132-2 of the optical fiber 132-1. An angle at which each of the seed beams L1 through Ln enters the optical input part 132-2 may preferably be within a range of the NA of the optical fiber 132-1. With this, the seed beams L1 through Ln that have entered the optical input part 132-2 can be propagated through the optical fiber 132-1. For example, when the optical fiber 132-1 is formed of PEEK and the diameter of the optical fiber 132-1 is 1 mm, the NA of the optical fiber 132-1 may be approximately 0.25.

The seed beams L1 through Ln that have entered the optical fiber 132-1 may be reflected multiple times at a boundary between the core and the clad of the optical fiber 132-1 while traveling through the optical fiber 132-1. With this, the seed beams L1 through Ln may be mixed, and reach the optical output portion 132-3 of the optical fiber 132-1. The mixed seed beams L1 through Ln may be outputted from the optical output part 132-3 as the diverging seed beam LL1.

The diverging seed beam LL1 outputted from the optical output part 132-3 of the optical fiber 132-1 may be focused by the focusing lens 132-4, and converted into the converging seed beam LL2. The converging seed beam LL2 may then be incident on the polarizer 204 of the regenerative amplifier 200. Here, the converging seed beam LL2 may include a portion that can be amplified in the regenerative amplifier 200. Here, when the seed beams L1 through Ln outputted from the respective master oscillators 101-1 through 101-n are linearly polarized and the optical fiber 132-1 is a polarization-maintenance optical fiber, the polarization state of the seed beams L1 through Ln may be preserved in the converging seed beam LL2. Further, the master oscillators 101-1 through 101-n and the optical fiber 132-1 may be positioned with respect to the polarizer 204 such that the converging seed beam LL2 may be incident on the polarizer 204 mostly as the S-polarization component. Accordingly, when the converging seed beam LL2 is incident on the polarizer 204, reduction in the amount of the seed beam reflected by the polarizer 204 and introduced into the regenerative amplifier 200 may be suppressed.

Of the converging seed beam LL2 that has entered the regenerative amplifier 200, a portion that has entered at an angle within the permissible entering angle range Rin and at a position within the permissible input-position offset range can be amplified in the regenerative amplifier 200 while traveling back and forth in the optical resonator of the regenerative amplifier 200. Thereafter, the seed beam amplified in the regenerative amplifier 200 may be outputted through the polarizer 206 as the laser beam 31a.

### 6.1.3 Effect

According to the third modification, the optical input part 132-2 of the optical fiber 132-1 may be positioned relatively freely with respect to the position at which the seed beam enters the regenerative amplifier 200. Thus, design flexibility of the laser apparatus may be increased. The seed beams L1 through Ln may be mixed in the optical fiber 132-1, and then be outputted from the optical output part 132-3 of the optical fiber 132-1 as the diverging seed beam LL1. The diverging seed beam LL1 may then be converted into the converging seed beam LL2 by the focusing lens 132-4, and may enter the regenerative amplifier 200 such that the converging seed beam LL2 may contain a portion that can be amplified in the regenerative amplifier 200.

In the third modification, an optical fiber has been used as a waveguide. However, this disclosure is not limited thereto. For example, a hollow light pipe may be used in place of the optical fiber 132-1. Alternatively, a columnar optical element capable of transmitting the seed beams L1 through Ln may be used in place of the optical fiber 132-1. The columnar optical element may be formed of ZnSe, for example. As another option, a high-reflection mirror including a hollow mirror substrate having a high-reflection film configured to reflect the seed beams L1 through Ln coated on the inner surface thereof may be used in place of the optical fiber 132-1. The focusing lens 132-4 may be replaced by a focusing mirror.

### 6.2 Optical System Including Beam Diffusion Element (Fourth Modification)

A diffuser may be used in place of the optical fiber 132-1.

### 6.1.2 Configuration

FIG. 6 schematically illustrates the configuration of a laser apparatus 3D including an optical system 142 according to a fourth modification. The laser apparatus 3D shown in FIG. 6 may be similar in configuration to the laser apparatus 3 shown in FIG. 2. However, the laser apparatus 3D may differ from the laser apparatus 3 in that the optical system 102 is replaced by the optical system 142. Further, the arrangement of the master oscillators 101-1 through 101-n may be changed in the laser apparatus 3D along with the replacement of the optical system 102 by the optical system 142. Further, the converging seed beam LL2, instead of the seed beam LL, may enter the regenerative amplifier 200.

The optical system 142 may include a diffuser 142-1 and a focusing lens 142-2. The diffuser 142-1 may be an optical element for converting the seed beams L1 through Ln into a diffused seed beam LL1.

The master oscillators 101-1 through 101-n may be positioned such that the seed beams L1 through Ln outputted from the respective master oscillators 101-1 through 101-n enter the diffuser 142-1.

The focusing lens 142-2 may be positioned such that the diffused seed beam LL1 outputted from the diffuser 142-1 is incident thereon, and enters the regenerative amplifier 200 after being converted into the converging seed beam LL2 by the focusing lens 142-2. Here, the focusing lens 142-2 may be positioned with respect to the regenerative amplifier 200 such that the converging beam LL2 enters the regenerative amplifier 200 at an angle within the permissible entering angle range Rin and at a position within the permissible input-position offset range. The focusing lens 142-2 can be omitted. In that case, of the diffused seed beam LL1, a portion that has entered the regenerative amplifier 200 at an angle within the permissible entering angle range Rin and at a position within the permissible input-position offset range may be amplified in the regenerative amplifier 200.

Here, the diffuser 142-1 may preferably be configured to be capable of transmitting the seed beam at wavelengths that can be amplified in the regenerative amplifier 200 containing CO₂ gas as a gain medium. The diffuser 142-1 may be formed of ZnSe or the like, for example. A plurality of fine concavities and convexities may be formed on a surface of the diffuser 142-1 for diffusing the seed beams L1 through Ln incident thereon. These concavities and convexities may be formed through sand blasting or the like. A diffractive optical element (DOE) in which a micro fly-eye lens array, a Fresnel lens, and the like are combined may be used in place of the diffuser 142-1.

### 6.2.2 Operation

The seed beams L1 through Ln outputted from the respective master oscillators 101-1 through 101-n may be incident on a predetermined region on the diffuser 142-1. The seed beams L1 through Ln may preferably be incident on the predetermined region at such an angle and a position that at least a portion of the converging seed beam LL2, which has been diffused by the diffuser 142-1 and focused by the focusing lens 142-2, can enter the regenerative amplifier 200 at an angle within the permissible entering angle range Rin and at a position within the permissible input-position offset range. More preferably, the seed beams L1 through Ln may be incident on the predetermined region at such an angle and a position that the portion of the converging seed beam LL2 that can enter the regenerative amplifier 200 at an angle within the permissible entering angle range Rin and at a position within the permissible input-position offset range is at the maximum.

The seed beams L1 through Ln may be diffused and mixed by the diffuser 142-1, and be outputted from the diffuser 142-1 as the diffused seed beam LL1. The diffused seed beam LL1 may be focused by the focusing lens 142-2, to thereby be converted into the converging seed beam LL2, and then be incident on the polarizer 204 of the regenerative amplifier 200. Here, the converging seed beam LL2 may include a portion that can be amplified in the regenerative amplifier 200.

Of the converging seed beam LL2 that has entered the regenerative amplifier 200, a portion that has entered the regenerative amplifier 200 at an angle within the permissible entering angle range Rin and at a position within the permissible input-position range may be amplified while traveling back and forth in the optical resonator of the regenerative amplifier 200. Thereafter, the seed beam amplified in the regenerative amplifier 200 may be outputted through the polarizer 206 as the laser beam 31a.

### 6.2.3 Effect

According to the fourth modification, the seed beams L1 through Ln may be diffused and mixed by using the diffuser 142-1 and may enter the regenerative amplifier 200 after being converted into the converging seed beam LL2 by the focusing lens 142-2. This configuration may facilitate the alignment of the optical elements to be provided on a beam path from the master oscillators 101-1 through 101-n to the regenerative amplifier 200.

Further, a DOE, in which a micro fly-eye lens array, a Fresnel lens, and the like are combined, may be used as an optical element for diffusing the seed beams L1 through Ln. In that case, a solid angle of the diffused seed beam LL1 can be adjusted. Accordingly, compared to a case where the diffuser 142-1 having grains on the surface thereof is used, the amount of the seed beams L1 through Ln to be introduced into the regenerative amplifier 200 can be increased.

Although a transmissive diffusion element has been used in the fourth modification, this disclosure is not limited thereto. For example, a reflective diffusion element may be used as well. Similarly, the focusing lens 142-2 may be replaced by a focusing mirror.

### 7. SUPPLEMENTARY DESCRIPTIONS

### 7.1 Modifications of Regenerative Amplifier

### 7.1.1 Configuration

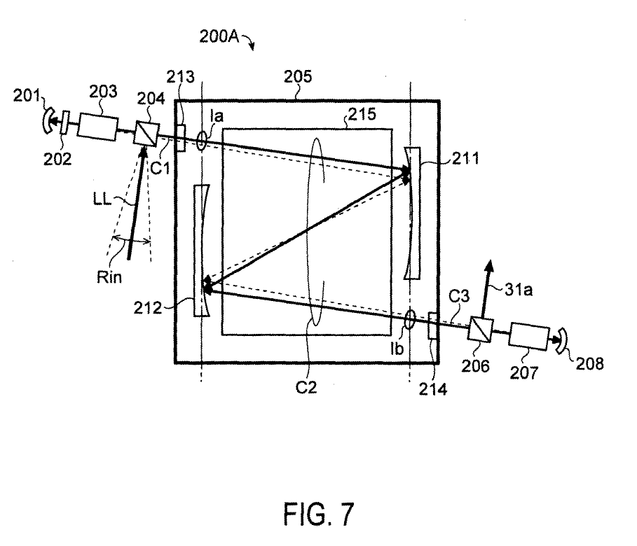

FIG. 7 schematically illustrates the configuration of a regenerative amplifier 200A according to a modification of the above-described embodiment. As illustrated in FIG. 7, the regenerative amplifier 200A may include the reverser mirrors 201 and 208, the quarter-wave plate 202, the EO Pockels cells 203 and 207, the polarizers 204 and 206, and the slab amplification unit 205. The reverser mirrors 201 and 208 may form an optical resonator. The quarter-wave plate 202, the EO Pockels cell 203, the polarizer 204, the slab amplification unit 205, the polarizer 206, and the EO Pockels cell 207 may be arranged in this order in the optical resonator formed by the reverser mirrors 201 and 208.

The slab amplification unit 205 may include concave high-reflection mirrors 211 and 212, and electrodes 215a and 215b (see FIG. 10). A space between the electrodes 215a and 215b may serve as an amplification region 215. The amplification region 215 may be filled with a gain medium, such as CO₂ gas.

The concave high-reflection mirrors 211 and 212 may be positioned such that a seed beam reflected by the respective mirrors travels along a multipass beam path C2 through the amplification region 215. The reflective surfaces of the respective concave high-reflection mirrors 211 and 212 may be designed such that an image of the seed beam LL on a beam path C1 at the input side (this may be referred to as an input-beam image Ia) can be transferred at a position on a beam path C3 at the output side as a transfer-beam image Ib. The position of the input-beam image Ia may be any position on the beam path C1.

In this way, the input-beam image Ia on the beam path C1 may be transferred on the beam path C3 as the transfer-beam image 1b. With this, even when the optical path length of the optical resonator is extended by forming a multipass (zigzag) beam path, an offset of the beam axis and the output position of the laser beam 31a with respect to the offset of the beam axis of the entering seed beam LL may be prevented from increasing.

In FIG. 7, the position of the input-beam image Ia is set to a position on the beam path C1 intersecting a plane containing the center of the reflective surface of the concave high-reflection mirror 212. Similarly, the position of the transfer-beam image Ib is set to a position on the beam path C3 intersecting a plane containing the center of the reflective surface of the concave high-reflection mirror 211. However, this disclosure is not limited thereto. For example, the input-beam image Ia of the seed beam LL at the reverser mirror 201 may be transferred as the transfer-beam image Ib at the reverser mirror 208. Alternatively, the input-beam image Ia of the seed beam LL at the polarizer 204 may be transferred as the transfer-beam image Ib at the polarizer 206.

### 7.1.2 Operation

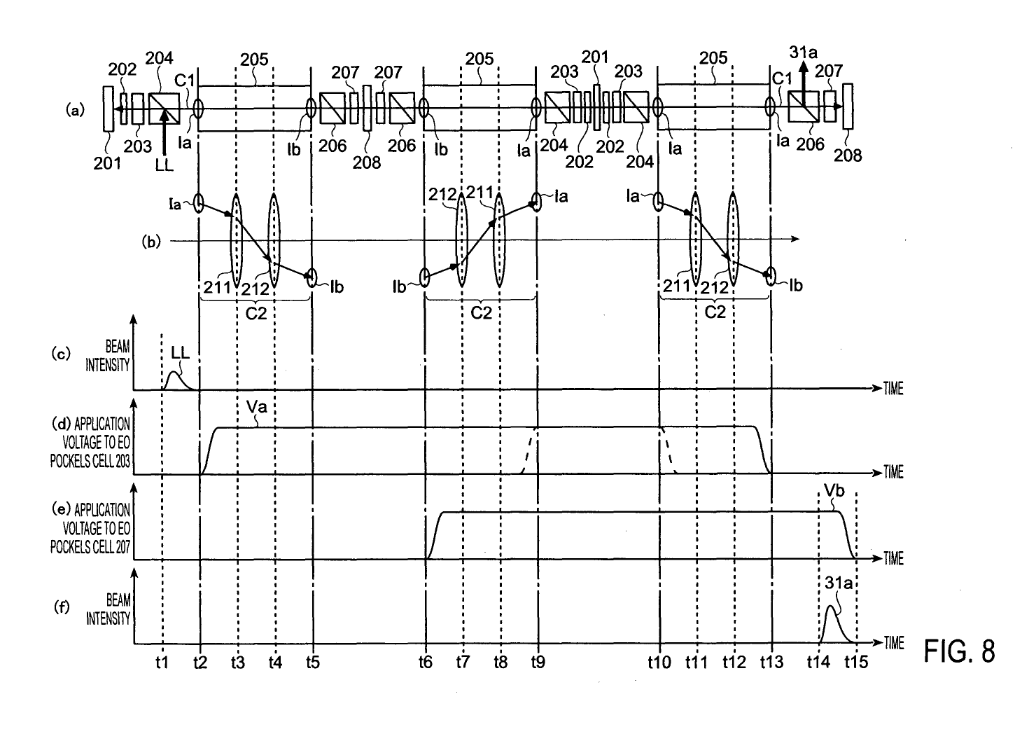

Operation of the regenerative amplifier 200A shown in FIG. 7 will now be described in detail with reference to FIG. 8. In FIG. 8, the seed beam LL that has entered the regenerative amplifier 200A may make one and a half round trips in the optical resonator formed by the reverser mirrors 201 and 208. Section (a) of FIG. 8 schematically illustrates the optical path in the regenerative amplifier 200A shown in FIG. 7, along the direction in which the laser beam travels in the regenerative amplifier 200A. Section (b) of FIG. 8 is an optical system diagram for schematically illustrating the input-beam images and the transfer-beam images at given positions in the slab amplification unit 205 of the regenerative amplifier 200A. Sections (c) through (f) of FIG. 8 show a timing chart of the general operation of the regenerative amplifier 200A.

As shown in FIG. 8, the seed beam LL may be incident on the polarizer 204 (see section (a)) at a timing t1 (see section (c)). The 5-polarization component of the seed beam LL incident on the polarizer 204 may be reflected with high reflectivity by the polarizer 204, to thereby be introduced into the regenerative amplifier 200A. The seed beam LL that has entered the regenerative amplifier 200A may first pass through the EO Pockels cell 203, to which a voltage Va is not applied, without a phase shift, and then be transmitted through the quarter-wave plate 202. The seed beam LL may be subjected to a 90-degree phase shift when being transmitted through the quarter-wave plate 202, to thereby be converted into a circularly polarized seed beam. Then, the seed beam LL may be reflected with high reflectivity by the reverser mirror 201, and again be transmitted through the quarter-wave plate 202. Here, the seed beam LL may be converted into a linearly polarized seed beam as it is transmitted through the quarter-wave plate 202. Subsequently, the seed beam LL may pass through the EO Pockels cell 203, to which the voltage Va is not applied (see section (d)), without a phase shift, and then be transmitted through the polarizer 204. Thereafter, the seed beam LL may enter the slab amplification unit 205 at a timing t2 (see section (a)). The seed beam LL that has entered the slab amplification unit 205 may be reflected by the concave high-reflection mirror 211 at a timing t3 (see section (b)), and then be reflected by the concave high-reflection mirror 212 at a timing t4 (see section (b)). With this, the seed beam LL may travel back and forth between the concave high-reflection mirrors 211 and 212. In this way, the seed beam LL may undergo multipass amplification.

Then, the amplified seed beam LL may be outputted from the slab amplification unit 205 at a timing t5. The outputted seed beam LL may be transmitted through the polarizer 206. Then, the seed beam LL may pass through the EO Pockels cell 207, to which a voltage Vb is not applied (see section (e)), without a phase shift, and then be reflected with high reflectivity by the reverser mirror 208. The seed beam LL that has been reflected by the reverser mirror 208 may pass through the EO Pockels cell 207, to which the voltage Vb is not applied (see section (e)), without a phase shift, and then be transmitted through the polarizer 206. Thereafter, the seed beam LL may again enter the slab amplification unit 205 at a timing t6 (see section (a)). The seed beam LL that has entered the slab amplification unit 205 may be reflected by the concave high-reflection mirror 212 at a timing t7 (see section (b)), and then be reflected by the concave high-reflection mirror 211 at a timing t8 (see section (b)). With this, the seed beam LL may travel back and forth between the concave high-reflection mirrors 212 and 211. In this way, the seed beam LL may again undergo multipass amplification.

Then, the amplified seed beam LL may be outputted from the slab amplification unit 205 at a timing t9. The outputted seed beam LL may then be transmitted through the polarizer 204, and pass through the EO Pockels cell 203, to which the voltage Va is applied (see section (d)). In the example shown in FIG. 8, a duration for which the voltage Va is applied to the EO Pockels cell 203 may be a duration containing at least timings t9 and t10, as shown in the broken line. The EO Pockets cell 203, to which the voltage Va is applied, may generate a 90-degree phase shift in the seed beam LL traveling therethrough. With this, the seed beam LL may be converted into a circularly polarized seed beam. Subsequently, the seed beam LL may be transmitted through the quarter-wave plate 202, to thereby be converted into a linearly polarized seed beam. Then, the seed beam LL may be reflected with high reflectivity by the reverser mirror 201, and may again be transmitted through the quarter-wave plate 202, to thereby be converted into a circularly polarized seed beam. The seed beam LL may then pass through the EO Pockels cell 203, to which the voltage Va is applied (see section (d)), to thereby be converted into a linearly polarized seed beam. Thereafter, the seed beam LL may be transmitted through the polarizer 204, and may again enter the slab amplification unit 205 at the timing t10 (see section (a)). The seed beam LL that has entered the slab amplification unit 205 may be reflected by the concave high-reflection mirror 211 at a timing t11 (see section (b)), and then be reflected by the concave high-reflection mirror 212 at a timing t12 (see section (b)). With this the seed beam LL may travel back and forth between the concave high-reflection mirrors 211 and 212. In this way, the seed beam LL may again undergo multipass amplification.

Thereafter, the amplified seed beam LL may be outputted from the slab amplification unit 205 at a timing t13. The outputted seed beam LL may then be transmitted through the polarizer 206, and pass through the EO Pockels cell 207, to which the voltage Vb is applied (see section (e)), to thereby be converted into a circularly polarized seed beam. In the example shown in FIG. 8, a duration for which the voltage Vb is applied to the EO Pockels cell 207 may be a duration containing at least timings t13 through t15. Further, the application of the voltage Vb may be stopped after the laser beam 31a is outputted from the regenerative amplifier 200A.

The seed beam LL may then be reflected with high reflectivity by the reverser mirror 208, and may again pass through the EO Pockels cell 207, to which the voltage Vb is applied (see section (e)), to thereby be converted into a linearly polarized seed beam. The seed beam LL may then be reflected with high reflectivity by the polarizer 206. With this, the seed beam LL may be outputted from the regenerative amplifier 200A as the laser beam 31a after the timing t14 (see section (f)).

In this way, the seed beam LL that has entered the regenerative amplifier 200A may be amplified as it travels back and forth through the amplification region 215 in the slab amplification unit 205 while traveling in the optical resonator formed by the reverser mirrors 201 and 208. The seed beam LL that has entered the regenerative amplifier 200A may travel back and forth in the optical resonator until it is amplified to beam intensity at or above a desired level.

With the above configuration, a beam image (input-beam image Ia) at the input side of the multipass beam path in the slab amplification unit 205 may be transferred as the transfer-beam image Ib at the output side of the multipass beam path. Accordingly, even when the optical path length of the optical resonator in the regenerative amplifier is extended by forming the multipass beam path, the offset in the beam axis of the laser beam 31a at the output side that may be caused due to the offset in the beam axis of the seed beam LL at the input side may be prevented from increasing in accordance with the increase in the optical path length. As a result, the beam axis of the laser beam 31 outputted from the regenerative amplifier 200A may be stabilized.

### 7.1.3 Another Modification

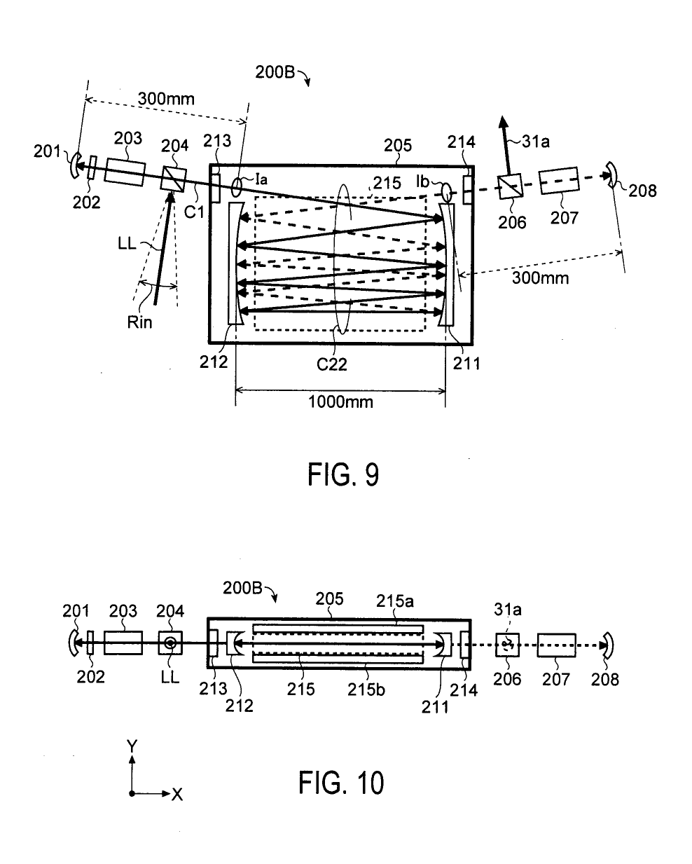

The regenerative amplifier 200A shown in FIG. 8 may be modified as shown in FIGS. 9 and 10. That is, as shown in FIGS. 9 and 10, the concave high-reflection mirrors 211 and 212 may be positioned such that a seed beam reflected by these mirrors may travel back and forth for a greater number of times than in the case shown in FIG. 8, traveling through the amplification region 215 along a multipass beam path C22. Here, FIG. 9 schematically illustrates the configuration of a regenerative amplifier 200B according to another modification. FIG. 10 is a side view of the regenerative amplifier 200B shown in FIG. 9.

### 7.2 Gain Properties in Amplifier Containing CO₂ Gas and Multi-line Amplification

Supplementary descriptions on an amplifier containing CO₂ gas a gain medium will be given below. Here, the amplifier containing CO₂ gas as a gain medium is not limited to the regenerative amplifier 200 (and the regenerative amplifiers 200A and 200B), but may include the amplifiers 301 through 303.

### 7.2.1 Gain Bandwidths in Amplifier Containing CO₂ Gas

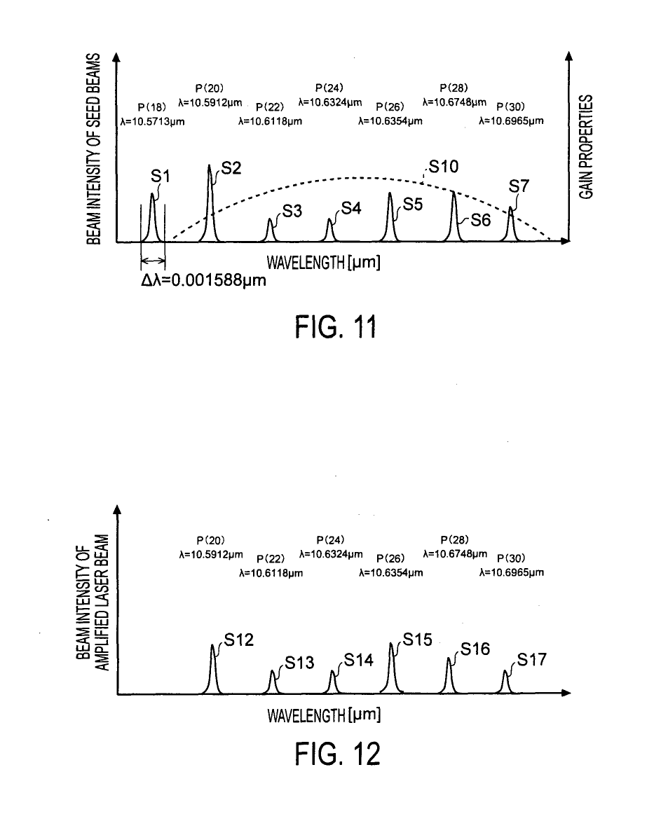

First, gain bandwidths in the amplifier containing CO₂ gas as a gain medium will be discussed. FIG. 11 shows gain properties of gain bandwidths in an amplifier containing CO₂ gas as a gain medium. FIG. 12 shows beam intensity of a seed beam LL amplified in accordance with the gain properties shown in FIG. 11. A gain medium, such as CO₂ gas, may have a plurality of gain bandwidths S1 through S7 (for example, modes P(18), P(20), P(22), P(24), P(26), P(28), P(30), and so forth). A width Δλ of each of the gain bandwidths S1 through S7 may be approximately 0.0016 μm, for example. Further, the gain properties of the gain bandwidths S1 through S7 may differ from one another.

Here, a wavelength spectral profile S10 of the seed beam LL is assumed to be such a broad spectral profile that can cover the modes P(20) through P(30), as indicated in the broken line in FIG. 11. If this is the case, as shown in FIG. 12, the seed beam LL that has been amplified by the gain medium containing CO₂ gas may be outputted from the amplifier as a laser beam having wavelength spectral profiles S12 through S17, which each has the beam intensity in accordance with the gain properties of the respective gain bandwidths S2 through S7.

### 7.2.2 Multi-Line Amplification Using Multiple Master Oscillators

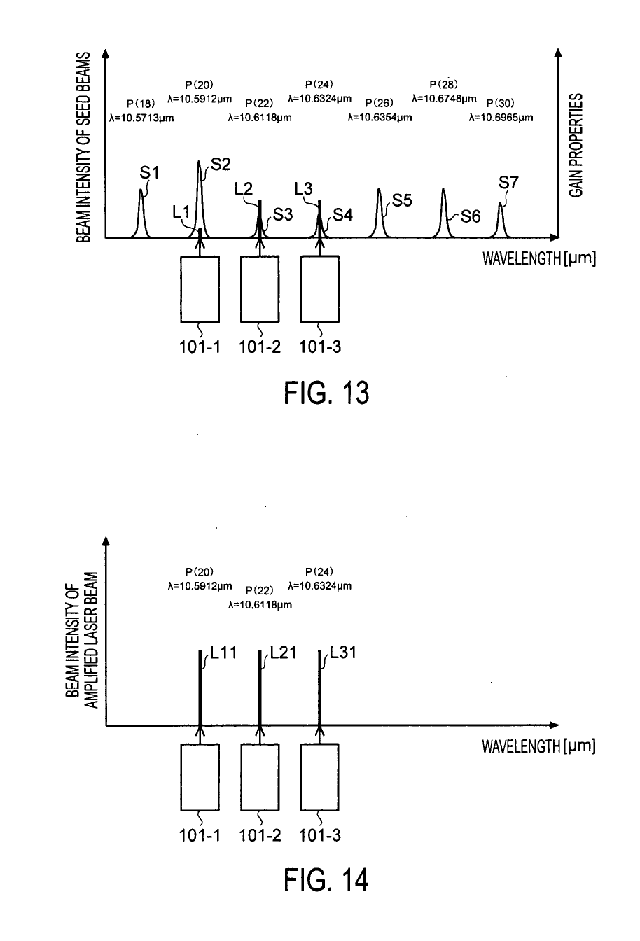

Multi-line amplification in an amplifier containing CO₂ gas as again medium will be discussed next. In this example, three master oscillators 101-1 through 101-3 may be used. FIG. 13 shows the gain properties of the gain bandwidths S1 through S7 corresponding to the modes P(18) through P(30) in the amplifier and the beam intensity of the seed beams L1 through L3. FIG. 14 shows the beam intensity of laser beams L11 through L31 amplified in accordance with the gain properties shown in FIG. 13.

The beam intensity of the seed beams outputted from the master oscillators may be adjusted in accordance with the gain properties of the corresponding gain bandwidths S1 through S7 at the modes P(18) through P(30), respectively, for example. In FIG. 13, the beam intensity of the seed beams L1 through L3 may be adjusted in accordance with the gain properties of the gain bandwidths S2 through S4. In this case, as shown in FIG. 14, the seed beams L1 through L3 may be amplified respectively in the associated gain bandwidths so that the beam intensity of each of the amplified laser beams L11 through L31 is substantially the same.

With the multi-line amplification, the gain can be increased by as much as 1.5 times, compared to the case where the seed beams L1 through L3 are amplified in a single-line at the mode P(20).

In the above-described example, the single-longitudinal-mode master oscillators 101-1 through 101-3 may each oscillate at different wavelengths, and the seed beams L1 through L3 outputted from the respective master oscillators 101-1 through 101-3 may be amplified in the gain bandwidths S2 through S4, respectively. However, this disclosure is not limited thereto. For example, two of the plurality of master oscillators may oscillate at wavelengths that are contained in the same gain bandwidth. Alternatively, at least one of a plurality of master oscillators may be a multi-longitudinal-mode master oscillator.

### 7.3 Simulation on Permissible Ranges

The permissible entering angle range and the permissible input-position offset range will now be discussed. The permissible ranges have been calculated through simulation based on the above-described embodiment. Hereinafter, the simulation carried out on the regenerative amplifier 200B shown in FIGS. 9 and 10 will be discussed.

### 7.3.1 Simulation Conditions

The simulation is carried out under the following conditions.

The distance between the concave high-reflection mirrors 211 and 212 is 1,000 mm.

The seed beam travels through the amplification region 215 nine times from the input of the seed beam into the slab amplification unit 205 to the output of the seed beam from the slab amplification unit 205.

The distance between the position of the input-beam image Ia and the reverser mirror 201 is 300 mm.

The distance between the position of the transfer-beam image Ib and the reverser mirror 208 is 300 mm.

The distance between the electrodes 215a and 215b is 3 mm.

The seed beam makes 10 round trips in the regenerative amplifier 200B.

The input-beam diameter of the seed beam LL, which serves as the reference, is 3 mm.

The input-beam wavefront curvature radius of the seed beam LL, which serves as the reference, is infinity.

Further, in the simulation, the reference with respect to the beam axis of the seed beam LL may be defined as follows. With reference to FIG. 10, the center axis of the regenerative amplifier 200B may be an axis which passes through substantially the center of each of the optical elements, excluding the concave high-reflection mirrors 211 and 212 and the windows 213 and 214 included in the regenerative amplifier 200B, and which lies on the intermediate plane between the planar electrodes 215a and 215b. On that basis, the beam axis of the seed beam LL when the beam axis coincides with the center axis of the regenerative amplifier 200B may be defined as the reference (=0). Here, a direction parallel to the center axis of the regenerative amplifier 200B is defined as the horizontal direction (X-direction in FIG. 10), and a direction perpendicular to a plane containing the axis of the regenerative amplifier 200B is defined as the vertical direction (Y-direction in FIG. 10). Further, the direction indicated by the arrow in the coordinate system shown in FIG. 10 is defined as a “positive” direction, and the direction opposite thereto may be defined as a “negative” direction.

### 7.3.2 Simulation Results

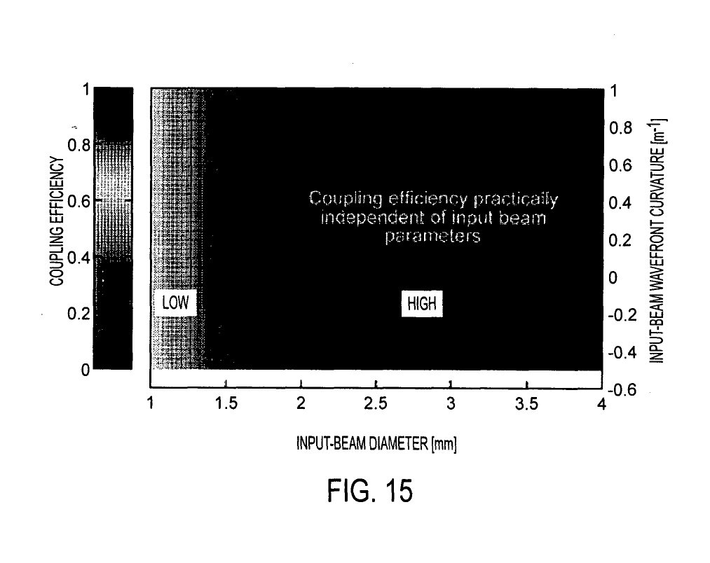

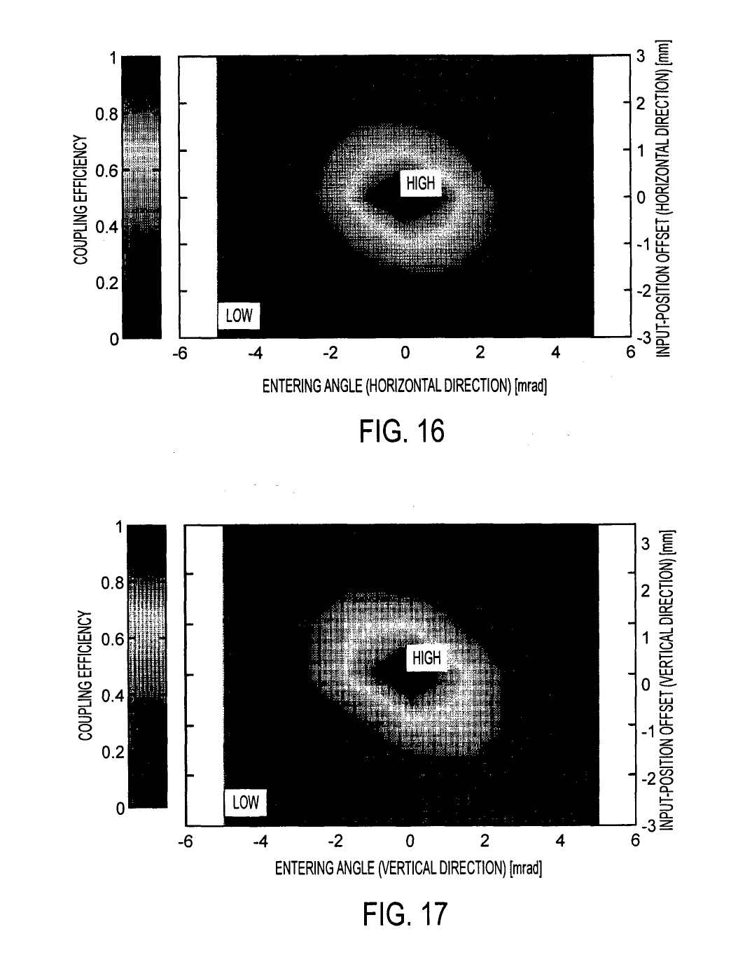

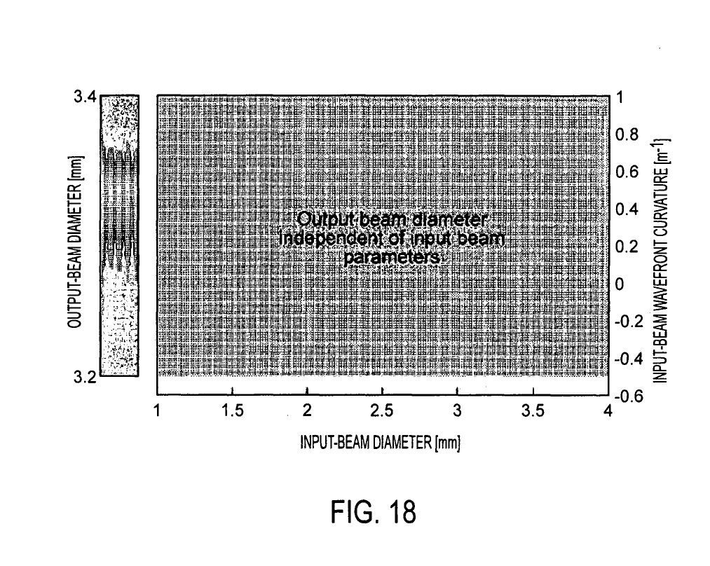

The simulation results are shown in FIGS. 15 through 19. FIG. 15 shows the relationship, obtained through simulation, among a coupling efficiency, an input-beam diameter of the seed beam LL, and an input-beam wavefront curvature of the seed beam LL. FIG. 16 shows the relationship, obtained through simulation, among a coupling efficiency, an entering angle of the seed beam LL, and an input-position offset of the seed beam LL in the horizontal direction. FIG. 17 shows the relationship, obtained through simulation, among a coupling efficiency, an entering angle of the seed beam LL, and an input-position offset of the seed beam LL in the vertical direction. FIG. 18 shows the relationship, obtained through simulation, among an input-beam diameter of the seed beam LL, an input-beam wavefront curvature of the seed beam LL, and an output-beam diameter of the amplified laser beam 31a.

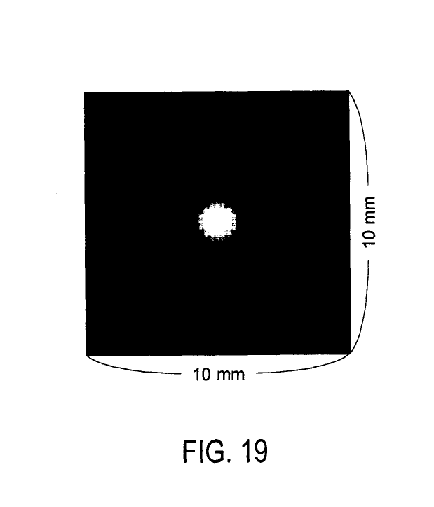

FIG. 19 shows the beam profile, obtained through simulation, of the amplified laser beam 31a.

As shown in FIG. 15, in a range where the input-beam wavefront curvature is between approximately −0.6 m⁻¹ and 1 m⁻¹, the coupling efficiency does not change much in accordance with the change in the input-beam wavefront curvature. Further, in a range where the input-beam diameter is between 1 mm and 2 mm, the coupling efficiency increases gradually from approximately 0.6 in accordance with the increase in the input-beam diameter. In the mean time, in a range where the input-beam diameter is between 2 mm and 4 mm, the coupling efficiency is substantially retained at 1, even with the increase in the input-beam diameter.

As shown in FIG. 16, in a range where the entering angle in the horizontal direction is between −2 mrad and +2 mrad, the coupling efficiency is at or above 0.6, advantageously. More advantageously, in a range where the entering angle in the horizontal direction is between −1.5 mrad and +1.5 mrad, the coupling efficiency is at or above 0.8. In a range where the input-position offset in the horizontal direction is between −1.3 mm and +1.3 mm, the coupling efficiency is at or above 0.6, advantageously. More advantageously, in a range where the input-position offset in the horizontal direction is between −0.5 mm and +0.5 mm, the coupling efficiency is at or above 0.8.

Similarly, as shown in FIG. 17, in a range where the entering angle in the vertical direction is between −2 mrad and +2 mrad, the coupling efficiency is at or above 0.6, advantageously. More advantageously, in a range where the entering angle in the vertical direction is between −1.8 mrad and +1.8 mrad, the coupling efficiency is at or above 0.8. In a range where the input-position offset in the vertical direction is between −1.2 mm and +1.2 mm, the coupling efficiency is at or above 0.6, advantageously. More advantageously, in a range where the input-position offset in the vertical direction is within −0.5 mm and +0.5 mm, the coupling efficiency is at or above 0.8.

As shown in FIG. 18, in a range where the input-beam diameter is between 1 mm and 4 mm, the output-beam diameter of the laser beam 31a is substantially retained at 3.3 mm, even with the increase in the input-beam diameter. In a range where the input-beam wavefront curvature is between −0.6 m⁻¹ and 1 m⁻¹, the output-beam diameter of the laser beam 31a is substantially retained at 3.3 mm, even with the change in the input-beam wavefront curvature. That is, the output-beam diameter of the laser beam 31a is substantially retained constant, even when the input-beam diameter and the input-beam wavefront curvature of the seed beam LL change.

As can be seen from FIG. 19, the following results have been obtained on the beam profile of the laser beam 31a at the output plane.

Beam diameter: 1.63 mm×1.69 mm

Wavefront curvature radius RoC: −3.65 m×−1.82 m (converging)

Beam quality M²: 1.14×1.34

Beam waist radius: 1.60 mm×1.60 mm

Beam waist position: 0.126 m×0.198 m (position relative to the output plane)

Based on the above, the following simulation results have been obtained as the permissible ranges for the seed beam LL.

Permissible range of beam diameter: 3.0 mm±50%

Permissible range of wavefront curvature radius of the seed beam: 1 m to infinity

Permissible entering angle range Rin of the beam axis (horizontal direction): ±2 mrad

Permissible entering angle range Rin of the beam axis (vertical direction): ±3 mrad

Permissible input-position offset range of the beam axis: ±1.5 mm

The above-described embodiments and the modifications thereof are merely examples for implementing this disclosure, and this disclosure is not limited thereto. Making various modifications according to the specifications or the like is within the scope of this disclosure, and other various embodiments are possible within the scope of this disclosure. For example, the modifications illustrated for particular ones of the embodiments can be applied to other embodiments as well (including the other embodiments described herein).

The terms used in this specification and the appended claims should be interpreted as “non-limiting.” For example, the terms “include” and “be included” should be interpreted as “including the stated elements but not limited to the stated elements.” The term “have” should be interpreted as “having the stated elements but not limited to the stated elements.” Further, the modifier “one (a/an)” should be interpreted as “at least one” or “one or more.”

What is claimed is:

1. A laser device, comprising:
master oscillators, each of the master oscillators being configured to output a seed beam;
a regenerative amplifier for amplifying seed beams from the respective master oscillators; and
an optical system configured to guide the seed beams from the master oscillators to the regenerative amplifier, such that at least one of the seed beams enters the regenerative amplifier at an angle that differs from an angle at which another seed beam enters the regenerative amplifier.

2. The laser device according to claim 1, wherein the optical system is configured to guide at least one of the seed beams to the regenerative amplifier at an angle inclined with respect to a designed input axis of the regenerative amplifier.

3. The laser device according to claim 1, wherein the optical system is configured to guide at least one of the seed beams to the regenerative amplifier at a position offset from the center of an input position of the regenerative amplifier.

4. The laser device according to claim 1, wherein the optical system includes at least one reflective optical element positioned to reflect at least one of the seed beams toward the regenerative amplifier.

5. The laser device according to claim 1, wherein the optical system includes at least one refractive optical element positioned to refract at least one of the seed beams toward the regenerative amplifier.

6. The laser device according to claim 1, wherein the optical system includes a waveguide for guiding at least one of the seed beams toward the regenerative amplifier.

7. The laser device according to claim 6, wherein the waveguide is an optical fiber.

8. The laser device according to claim 6, wherein the optical system further includes a focusing optical element for converging and guiding the seed beams from the waveguide toward the regenerative amplifier.

9. The laser device according to claim 1, wherein the optical system includes a diffusion optical element for diffusing the seed beams.

10. The laser device according to claim 9, wherein the optical system further includes a focusing optical element for converging and guiding the seed beams diffused by the diffusion optical element toward the regenerative amplifier.

11. The laser device according to claim 1, wherein the regenerative amplifier includes:
an amplification region for amplifying the seed beams; and
an optical element for causing the seed beams to make at least one round trip through the amplification region.

12. The laser device according to claim 1, wherein at least one of the master oscillators is configured to output a seed beam at a different wavelength from another master oscillator.

13. The laser device according to claim 1, wherein at least one of the master oscillators is configured to output a seed beam at the same wavelength as another master oscillator.

14. A laser apparatus, comprising:
the laser device of claim 1; and
an amplifier for amplifying an amplified laser beam from the laser device.

15. An extreme ultraviolet light generation system, comprising:
the laser apparatus of claim 14;
a chamber having an inlet for introducing the laser beam from the laser apparatus into the chamber;
a target supply unit for supplying a target material into the chamber;
a focusing optical system for focusing the laser beam in the chamber; and
a collector mirror for collecting extreme ultraviolet light emitted as the target material is irradiated by the laser beam in the chamber.
